(19) United States
(12) Patent Application Publication
(10) Pub. No.: US 2025/0267362 A1
(43) Pub. Date: Aug. 21, 2025

(54) IMAGE PROCESSING APPARATUS, IMAGE CAPTURING APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Yujiro SOEDA, Kanagawa (JP)

(21) Appl. No.: 19/037,408

(22) Filed: Jan. 27, 2025

(30) Foreign Application Priority Data
Feb. 15, 2024 (JP) 2024-021445

(51) Int. Cl. H04N 23/67; H04N 23/611; H04N 23/63

(52) U.S. Cl. CPC H04N 23/675; H04N 23/611; H04N 23/635

(57) ABSTRACT

At least one processor detects a subject in an image, displays the image and a detection region of the subject, designates, as a non-detection region, the detection region displayed, holds information of the non-detection region designated, and decides, based on the information of the non-detection region, a non-detection region in another image displayed after the image.

### BACKGROUND OF THE INVENTION

### Field of the Invention

The present invention relates to an image processing apparatus, an image capturing apparatus, an image processing method, and a non-transitory computer-readable storage medium.

### Description of the Related Art

Object detection processing of detecting an object from an image is applied to the function of an image capturing apparatus such as a digital camera. The target of the object detection processing has been an object of a specific category such as a face or a face organ (a pupil, a nose, or a mouth) of a person, or a whole body of a person. In recent years, along with development of deep learning, a technique of detecting an animal, a vehicle, and the like by causing a detector to learn object likelihoods using information of objects of various categories has been implemented. In a digital camera, the object detection processing is applied to an auto-focus (AF) technique of automatically focusing on a detection object as a subject, auto-exposure (AE) processing of controlling to the proper exposure, auto white balance (AWB) processing of performing tone correction, and the like.

The AF function using the object detection processing focuses on an object recognized as a subject by the camera but the object may differ from the intention of the user of the camera. A case where the object differs from the user's intention is, for example, a case where the object detection processing of the camera erroneously detects, as a face, an object that is not a face, and focuses on the object that is not a face. Furthermore, a case where the user wants to make the camera focus on a face of a horse in a horse race scene but the camera focuses on a face of a jockey is also considered.

As a method of avoiding a situation in which an object differing from a user's intention is focused on, the user designates, as a non-priority subject, a specific subject detected in a live image displayed on a display of a camera, thereby controlling not to focus on the non-priority subject (Japanese Patent Laid-Open No. 2013-157675).

### SUMMARY OF THE INVENTION

According to the present invention, it is possible to more efficiently exclude, from detection targets, a subject differing from a user's intention.

Some embodiments of the present disclosure provide an image processing apparatus comprising at least one processor, and at least one memory coupled to the at least one processor. The at least one memory stores instructions that, when executed by the at least one processor, cause the at least one processor to detect a subject in an image, display the image and a detection region of the subject, designate, as a non-detection region, the detection region displayed, hold information of the non-detection region designated, and decide, based on the information of the non-detection region, a non-detection region in another image displayed after the image.

Some embodiments of the present disclosure provide a method comprising detecting a subject in an image, displaying the image and a detection region of the subject, designating, as a non-detection region, the detection region displayed, holding information of the non-detection region designated, and deciding, based on the information of the non-detection region, a non-detection region in another image displayed after the image.

Some embodiments of the present disclosure provide a non-transitory computer readable storage medium storing instructions that, when executed by a computer, cause the computer to perform a method comprising detecting a subject in an image, displaying the image and a detection region of the subject, designating, as a non-detection region, the detection region displayed, holding information of the non-detection region designated, and deciding, based on the information of the non-detection region, a non-detection region in another image displayed after the image.

Further features of the present invention will become apparent from the following description of exemplary embodiments (with reference to the attached drawings).

### BRIEF DESCRIPTION OF THE DRAWINGS

FIG. 1 is a block diagram showing an example of the functional configuration of an image processing apparatus according to the first embodiment;

FIG. 2 is a flowchart illustrating processing of the image processing apparatus according to the first embodiment;

FIG. 3A is a view showing an example of an input image according to the first embodiment;

FIG. 3B is a view showing an example of the input image according to the first embodiment;

FIG. 4 is a view showing a detection region according to Modifications 1 and 2 of the first embodiment;

FIG. 5 is a block diagram showing an example of the functional configuration of an image processing apparatus according to the second embodiment;

FIG. 6 is a flowchart illustrating processing of the image processing apparatus according to the second embodiment;

FIG. 7 is a block diagram showing an example of the functional configuration of an image processing apparatus according to the third embodiment;

FIG. 8 is a flowchart illustrating processing of the image processing apparatus according to the third embodiment;

FIG. 9 is a block diagram showing an example of the functional configuration of an image processing apparatus according to the fourth embodiment;

FIG. 10 is a flowchart illustrating processing of the image processing apparatus according to the fourth embodiment;

FIG. 11A is a view showing an example of an input image according to the fourth embodiment; and

FIG. 11B is a view showing an example of the input image according to the fourth embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

In the first embodiment, an image processing apparatus is a digital camera. This embodiment will describe an example in which focusing by AF is not executed for a non-detection region of a next input image (another image) decided based on the image feature amount of a non-detection region designated in the first input image. In this embodiment, the image processing apparatus is a digital camera, but the present invention is not limited to this. In addition, processing that is not executed for the non-detection target of the next input image is not limited to the AF processing and may be auto-exposure (AE) processing of controlling to the proper exposure and auto white balance (AWB) processing of performing tone correction for a light source.

### Apparatus Configuration

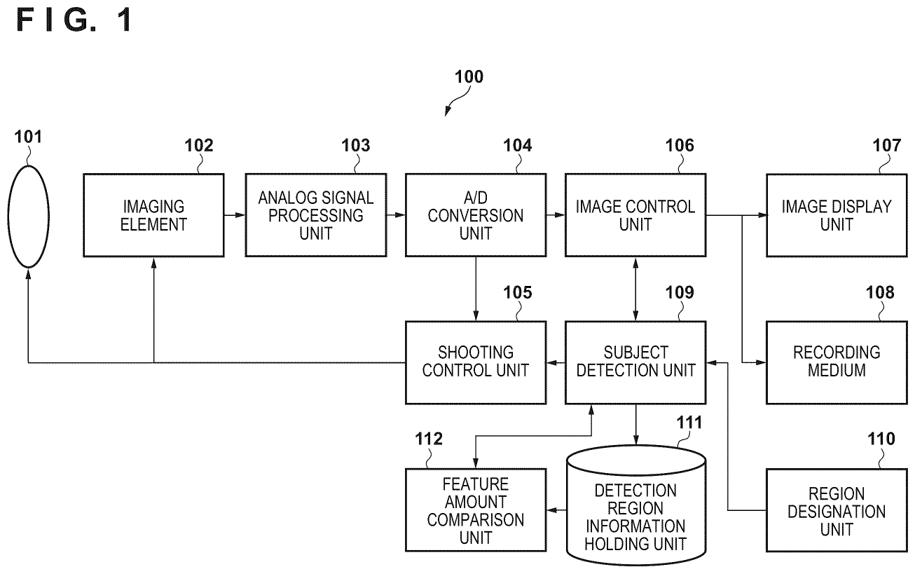

FIG. 1 is a block diagram showing an example of the functional configuration of an image processing apparatus according to the first embodiment.

An image processing apparatus 100 has a function of detecting a face of a person as a specific subject from shot image data and focusing on the detected face of the person.

A light beam representing a subject image is collected by an imaging lens 101 and enters an imaging element 102 formed from an image sensor such as a CCD or CMOS sensor.

The imaging element 102 outputs an electrical signal corresponding to the intensity of the incident light beam on a pixel basis. This electrical signal is a video signal. The video signal output from the imaging element 102 is processed by analog signal processing such as Correlated Double Sampling (CDS) in an analog signal processing unit 103.

The video signal output from the analog signal processing unit 103 is converted into a digital data format in an A/D conversion unit 104, and input to a shooting control unit 105 and an image control unit 106.

The image control unit 106 performs image processing such as gamma correction and white balance processing. In addition to normal image processing, the image control unit 106 performs image control using detection region information in an image supplied from a subject detection unit 109 to be described later. Furthermore, the image control unit 106 serves as a display control means for superimposing a rectangular detection frame (to be referred to as a bounding box hereinafter) on a subject (for example, a face of a person) detected by the subject detection unit 109.

The image control unit 106 decides display or non-display of the bounding box on the subject based on the reliability of the subject detected by the subject detection unit 109. For example, if the reliability of the subject exceeds a predetermined threshold, the image control unit 106 superimposes and displays the bounding box on the subject. When superimposing and displaying the bounding box on the subject, the image control unit 106 decides the display position and size of the bounding box based on the position and size of the subject detected by the subject detection unit 109. Furthermore, when the user designates a non-detection region by a region designation unit 110 to be described later, the image control unit 106 can explicitly indicate, to the user, that the non-detection region is designated, by changing the color, thickness, line type, and the like of the bounding box. The video signal output from the image control unit 106 is transmitted to an image display unit 107.

The image display unit 107 is, for example, a display means such as an LCD or an organic EL display, and displays the video signal. By sequentially displaying, on the image display unit 107, shot images continuous in time series, the image display unit 107 can be caused to function as an electronic viewfinder (EVF).

The video signal is recorded in a recording medium 108 (for example, a detachable memory card). The recording destination of the video signal may be an internal memory of the camera or an external device connected to the camera in a communication-enabling manner. The video signal output from the image control unit 106 is supplied to the subject detection unit 109.

The subject detection unit 109 is a detection means for detecting a specific subject in an input image, and specifies the number of subjects and a region. The specific subject is, for example, a face of a person. A method of detecting the specific subject is a known face detection method. The known technique of face detection includes a method using knowledge (skin color information and parts such as the eyes, nose, and mouth) concerning a face and a method of forming a detector for face detection by a learning algorithm represented by a Convolutional Neural Network (CNN). To improve face detection accuracy, it is general to perform face detection by using these methods in combination.

The output information of the subject detection unit 109 includes, for example, the image feature amounts, positions, sizes, and tilts of the detected subjects, the reliabilities of the detection results, and detection categories. The detection category is information indicating the detection task (person detection task, animal detection task, vehicle detection task, or the like) of the detector used to detect the subject. The image feature amount includes, for example, the color information, luminance information, and CNN feature amount of the detection region. In this embodiment, the person detection task will be exemplified but a task obtained by arbitrarily combining the person detection task, the animal detection task, and the vehicle detection task may be used. At this time, based on the reliability output from the detector and the like, the detection category of the detection region can be recognized. Furthermore, if an image includes a plurality of objects of different detection categories, it is possible to decide, as a main subject, an object detected in a specific detection category based on the priorities of the detection tasks of the subject detection unit 109.

The region designation unit 110 serves as, for example, an input interface such as a touch panel, buttons, or a joy stick. The touch panel may be integrated with the screen of the image display unit 107. The user can designate, via the region designation unit 110 (designation means), a non-detection region from the detection regions of the subjects detected by the subject detection unit 109.

For example, the bounding box is superimposed and displayed on the face of the person detected by the subject detection unit 109 on the image display unit 107. The user can press a portion in the bounding box displayed on the touch panel to designate, as a non-detection subject, the subject in the bounding box. Alternatively, the user may designate the non-detection subject by operating the joy stick and the buttons but the present invention is not limited to this.

The subject detection unit 109 holds, in a detection region information holding unit 111 (holding means), the image feature amount in the detection region (that is, the bounding box) including the position on the image designated by the user using the region designation unit 110.

The shooting control unit 105 serves as a shooting control means for controlling a focus control mechanism and an exposure control mechanism (neither of which is shown) of the imaging lens 101 (imaging means) based on the video signal output from the A/D conversion unit 104. The shooting control unit 105 uses information of the detection region supplied from the subject detection unit 109 to control the focus control mechanism and the exposure control mechanism. Note that the shooting control unit 105 controls the imaging lens 101 (imaging means) not to focus on the non-detection region.

A feature amount comparison unit 112 compares the image feature amount of the detection region detected by the subject detection unit 109 with the image feature amount of the non-detection region held in the detection region information holding unit 111 from a frame (image) in which the user designates the non-detection subject. At this time, the subject detection unit 109 serves as an acquisition means for acquiring the image feature amount of the detection region detected by the subject detection unit 109 and the image feature amount of the non-detection region held in the detection region information holding unit 111. Furthermore, the feature amount comparison unit 112 serves as a decision means for deciding, as the non-detection region, the detection region with the image feature amount having a high correlation with the image feature amount of the non-detection region.

Since a subject in the decided non-detection region is excluded from subjects to be detected by the subject detection unit 109, display of a bounding box and focusing are not performed for the non-detection subject. The state in which display of a bounding box and focusing are not performed for the non-detection subject continues even from the next frame (next image).

In this case, if the user presses a predetermined button of the region designation unit 110 while the designation of the non-detection region continues, the setting of continuing the designation of the non-detection region may be canceled to set the non-detection region in a state in which the region can be detected again, that is, set the non-detection region as a detection region. Furthermore, the detection region information holding unit 111 is allowed to store the image feature amount of the non-detection region even after power-off of the image processing apparatus 100 (digital camera), thereby permanently maintaining the designation of the non-detection region.

### Processing Procedure

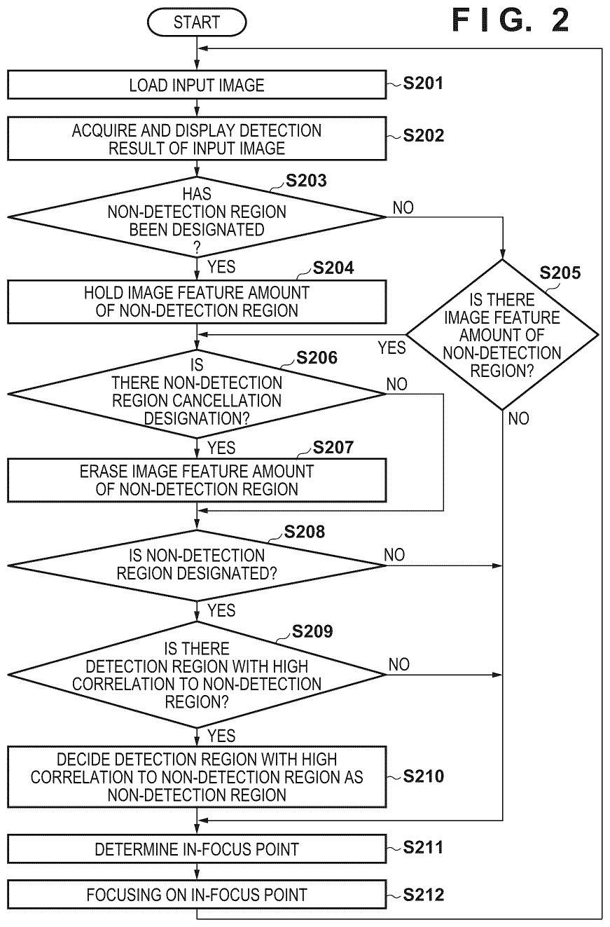

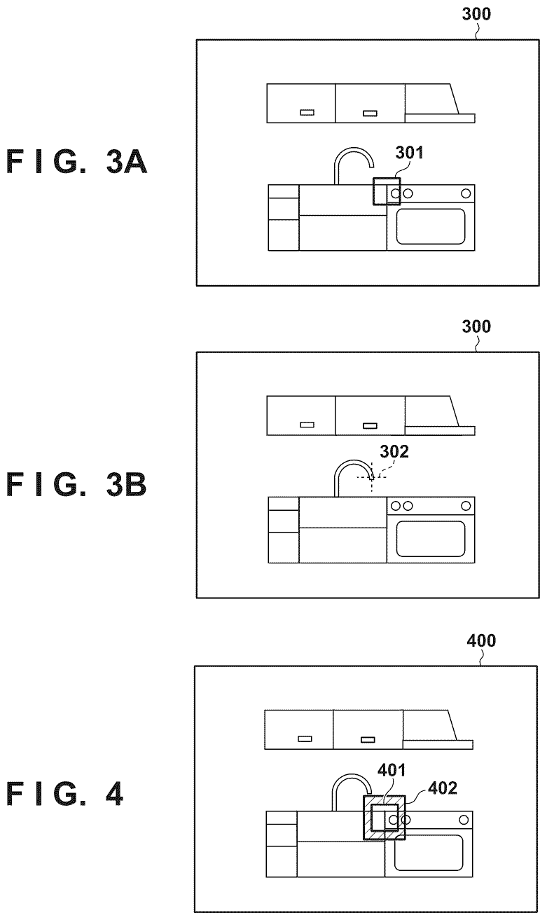

A processing procedure according to this embodiment will be described next with reference to FIGS. 2, 3A, and 3B. FIG. 2 is a flowchart illustrating processing of the image processing apparatus according to the first embodiment. Note that the processing shown in FIG. 2 is implemented when a CPU of the image processing apparatus 100 deploys a control program stored in a ROM to the work area of a RAM and executes it after power-on of the image processing apparatus 100 (digital camera).

The shooting control unit 105 loads a captured image as an input image 300 (step S201).

FIGS. 3A and 3B are views each showing an example of an input image according to the first embodiment. FIG. 3A shows the input image 300 obtained by capturing a kitchen. Since the subject detection unit 109 to be described later erroneously detects part of kitchen facilities as a face of a person, a detection region 301 (indicated by a bounding box) is displayed on the part of the kitchen facilities. Note that one detection region 301 exists in FIG. 3A but a plurality of detection regions 301 may exist. The explanation returns to FIG. 2.

The subject detection unit 109 obtains a detection result including the detection region 301 of the input image 300 (step S202). The detection result includes the number of detection regions and the image feature amount, position, size, and reliability of each detection region. As shown in FIG. 3A, the image display unit 107 notifies the user of the detection result by displaying the detection region 301 on the input image 300.

At this time, the user confirms the detection region 301 of the input image 300, and notices that the detection region 301 does not include a subject (that is, a face of a person) intended by the user. The user does not want the detection region 301 (the part of the kitchen as a non-detection subject) to be focused on. In this specification, the non-detection subject indicates a subject that the user does not want the image processing apparatus 100 to detect. The non-detection region indicates a region obtained by surrounding the non-detection subject by the bounding box. If the user designates the specific detection region 301 among the detection regions of the input image 300 using the region designation unit 110 (YES in step S203), the image control unit 106 changes the detection region 301 to the non-detection region. Assume that the detection region 301 indicates the non-detection region.

The detection region information holding unit 111 holds the image feature amount of the non-detection region designated by the user (step S204).

If the user designates no non-detection region (NO in step S203), the subject detection unit 109 determines whether the detection region information holding unit 111 holds the image feature amount of the non-detection region (step S205).

If the detection region information holding unit 111 holds no image feature amount of the non-detection region (NO in step S205), the subject detection unit 109 advances the process to step S211.

If the detection region information holding unit 111 holds the image feature amount of the non-detection region (YES in step S205), after the processing in step S204, the subject detection unit 109 determines whether the user designates cancellation of the non-detection region (step S206). The designation of cancellation of the non-detection region indicates designation of canceling the designation of the non-detection region, and more specifically, designation of changing the non-detection region to the detection region. For example, the user can press an arbitrary button of the region designation unit 110 (cancellation means) to designate cancellation of the non-detection region.

If the user designates cancellation of the non-detection region (YES in step S206), the subject detection unit 109 erases the image feature amount of the non-detection region from the detection region information holding unit 111 (step S207), and advances the process to step S208.

If the user does not designate cancellation of the non-detection region (NO in step S206), the subject detection unit 109 advances the process to step S208.

The shooting control unit 105 determines whether the user designates the non-detection region (step S208).

If the user designates no non-detection region (NO in step S208), the shooting control unit 105 determines an in-focus point (step S211). In this example, a subject at a position closest to the image processing apparatus 100, a subject that occupies a large area of the input image 300, or a subject existing at a position close to the center of the input image 300 is set as a main subject (that is, an in-focus point). On the other hand, if there is no subject in the input image 300, a target object at a position close to the image processing apparatus 100 or the center of the input image 300 is set as an in-focus point. For example, FIG. 3B shows a center 302 of the input image 300 as an in-focus point.

The image processing apparatus 100 focuses on the in-focus point (for example, the center 302 in FIG. 3B) decided by the shooting control unit 105 in step S211 (step S212). After completion of focusing of the image processing apparatus 100, the shooting control unit 105 loads the next input image 300. The explanation returns to a case where YES is determined in step S208.

If the user designates the non-detection region (YES in step S208), the feature amount comparison unit 112 compares the image feature amount of the detection region of the input image 300 with the image feature amount of the non-detection region (in this example, the detection region 301) held in the detection region information holding unit 111 (step S209).

If there exists the detection region (not shown) with the image feature amount having a high correlation with the image feature amount of the non-detection region (YES in step S209), the feature amount comparison unit 112 decides the detection region as the non-detection region (step S210), and advances the process to step S211.

If there is no detection region (not shown) with the image feature amount having a high correlation with the image feature amount of the non-detection region (NO in step S209), the feature amount comparison unit 112 advances the process to step S211.

Steps S203 to S207 of FIG. 2 correspond to the designation processing of the non-detection region and the cancellation designation processing of the non-detection region. Steps S208 to S212 correspond to the processing of deciding, as the non-detection region, the detection region on the next input image, which has a high correlation with the non-detection region. The order of these processes may be reversed.

According to the first embodiment, it is possible to prevent detection of a subject differing from a user's intention and focusing on the subject.

### Modification 1

Modification 1 of the first embodiment will be described. Only the difference from the first embodiment will be described with reference to FIGS. 1 and 4. FIG. 4 is a view showing a detection region according to Modifications 1 and 2. FIG. 4 shows an input image 400 obtained by capturing a kitchen, similar to the input image 300 shown in FIG. 3A.

In Modification 1, the subject detection unit 109 serves as an acquisition means for acquiring the image feature amount of a detection region 402 including a detection region 401 of a non-detection subject (part of the kitchen) designated by the user and a peripheral region of the detection region 401. Note that the detection regions 401 and 402 are designated, by the user, not to be detected, and are thus “non-detection regions”. On the other hand, if the detection regions 401 and 402 are not designated, by the user, not to be detected, they remain to be the detection regions. The peripheral region of the detection region 401 is the entire peripheral region (indicated by a hatched portion) of the detection region 401, as shown in FIG. 4, but may be a partial peripheral region of the detection region 401. The subject detection unit 109 acquires the image feature amount of the detection region 402 having an area wider than that of the detection region 301 shown in FIG. 3A. This decides, as the non-detection region, only the detection region with the image feature amount having a high correlation with the image feature amount of the detection region 402. If a face of a person that the user wants to detect is outside the peripheral region of the detection region 401 shown in FIG. 4, the detection accuracy of the face of the person is not degraded.

According to Modification 1, it is possible to prevent detection of a subject differing from a user's intention and focusing on the subject without degrading the detection accuracy of the subject that the user wants to detect.

### Modification 2

Modification 2 of the first embodiment will be described. Modification 2 is an example obtained by modifying the detection region of Modification 1 and only the difference from Modification 1 will be described. Similar to Modification 1, Modification 2 will be described with reference to FIG. 4.

In Modification 1, the subject detection unit 109 acquires the image feature amount of the detection region 402 (=detection region 401+peripheral region of detection region 401) wider than the detection region 401 of the non-detection subject shown in FIG. 4. In Modification 2, the subject detection unit 109 acquires the image feature amount of a hatched region between the detection region 401 and the detection region 402 having an area wider than that of the detection region 401. That is, the subject detection unit 109 acquires the image feature amount of only the peripheral region of the detection region 401. In this way, similar to Modification 1, if a face of a person to be originally detected is outside the peripheral region of the detection region 401 shown in FIG. 4, the detection accuracy of the face of the person is not degraded.

As described above, according to Modification 2, it is possible to prevent detection of a subject differing from a user's intention and focusing on the subject without degrading the detection accuracy of the subject to be originally detected.

### Modification 3

Modification 3 of the first embodiment will be described. Modification 3 will describe an example of control of not detecting a non-detection subject in the next input image by learning the image feature amount of the non-detection region (for example, the detection region 401 shown in FIG. 4) designated by the user. Note that the image processing apparatus 100 includes a learning unit (learning means) (not shown) that causes the detector to learn the image feature amount of the non-detection subject.

The image feature amount of the non-detection region (for example, the detection region 401 shown in FIG. 4) designated by the user is continuously held in the detection region information holding unit 111. By using the learning unit (not shown) and the image feature amount held in the detection region information holding unit 111, learning of the detector of the subject detection unit 109 is performed not to detect the non-detection subject from the next input image. The detector learns the image feature amount of the non-detection subject, thereby making it possible to prevent detection of a subject differing from a user's intention and focusing on the subject.

### Second Embodiment

In the first embodiment, the image processing apparatus 100 is a digital camera, and decides, as the non-detection region, the detection region with the image feature amount having a high correlation with the image feature amount of the non-detection region based on the image feature amount of the non-detection region. Furthermore, an example in which the shooting control unit 105 controls to prevent the imaging lens 101 from focusing on the decided non-detection region by AF has been explained. Similar to the first embodiment, the second embodiment will describe an example in which an image processing apparatus 100 is a digital camera and prevents detection of a subject differing from a user's intention based on “the reliability of a non-detection region”. Similar to the first embodiment, the second embodiment assumes a scene in which a subject detection unit 109 erroneously detects part of a kitchen as a face of a person, as indicated by an input image 300 shown in FIG. 3A.

### Apparatus Configuration

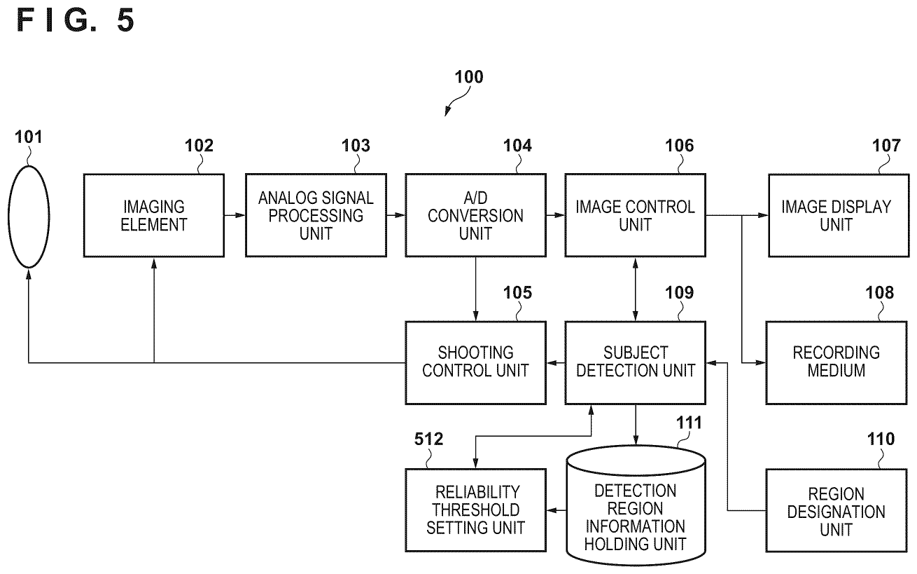

FIG. 5 is a block diagram showing an example of the functional configuration of an image processing apparatus according to the second embodiment. The image processing apparatus 100 according to the second embodiment includes a reliability threshold setting unit 512 as a decision means different from that in the first embodiment.

Similar to the image processing apparatus 100 according to the first embodiment, the image processing apparatus 100 has a function of detecting a face of a person as a specific subject from an input image and focusing on the detected face of the person.

The same components as those in the first embodiment are given with the same names and reference numerals. A repetitive description of the same components will be omitted.

In this example, the reliability of the non-detection region is one of pieces of information output from the subject detection unit 109, and is a value representing the likelihood of a subject. For example, if a face of a person is detected, the reliability is a value quantitatively representing the face likelihood of the person of the detected subject. The subject with reliability exceeding a reliability threshold held by the image processing apparatus 100 is detected. As the threshold is higher, the false positive rate decreases but the true positive rate also decreases. As the threshold is lower, the true positive rate increases but the false positive rate also increases.

The subject detection unit 109 holds, in a detection region information holding unit 111, the reliability (for example, 150) of the non-detection region including a position on the input image designated by the user using a region designation unit 110.

The reliability threshold setting unit 512 sets a reliability threshold (for example, 170) higher than the reliability (for example, 150) held in the detection region information holding unit 111 from a frame (image) in which the non-detection region is designated. By setting, as the next reliability threshold (for example, 170), a value higher than the initial reliability threshold (for example, 140), it is possible to suppress a detection error of a subject that is not intended by the user.

### Processing Procedure

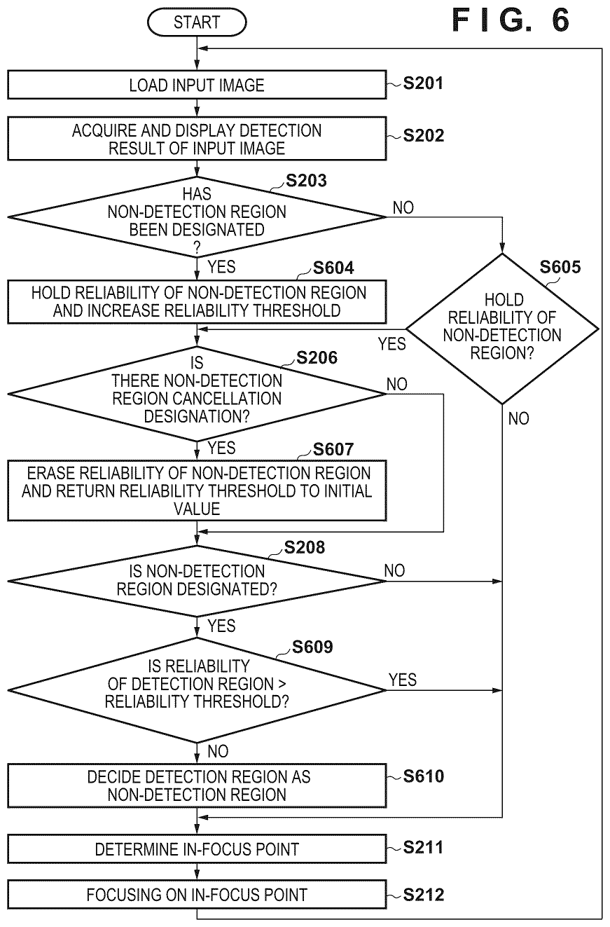

A method of designating a non-detection region according to this embodiment will be described next. FIG. 6 is a flowchart illustrating processing of the image processing apparatus according to the second embodiment. The processing shown in FIG. 6 is implemented when a CPU of the image processing apparatus 100 deploys a control program stored in a ROM to the work area of a RAM and executes it after power-on of the image processing apparatus 100 (digital camera). In FIG. 6, the same processing steps as in FIG. 2 of the first embodiment are denoted by the same step numbers and a description thereof will be omitted.

In step S604, an image control unit 106 changes, to a non-detection region, the detection region designated by the user using the region designation unit 110, and the detection region information holding unit 111 holds the reliability of the non-detection region. The reliability threshold setting unit 512 set, as the next reliability threshold, a value higher than the initial reliability threshold.

In step S605, the subject detection unit 109 determines whether the detection region information holding unit 111 holds the reliability of the non-detection region. If the reliability of the non-detection region is not held (NO in step S605), the subject detection unit 109 advances the process to step S211.

If the reliability of the non-detection region is held (YES in step S605), the subject detection unit 109 advances the process to step S206.

In step S607, the subject detection unit 109 erases the reliability of the non-detection region from the detection region information holding unit 111, returns the reliability threshold to the initial value, and advances the process to step S208.

In step S609, the reliability threshold setting unit 512 compares the reliability of the detection region on the input image with the reliability threshold. If the reliability of the detection region exceeds the reliability threshold (YES in step S609), the reliability threshold setting unit 512 advances the process to step S211.

If the reliability of the detection region on the input image does not exceed the reliability threshold (NO in step S609), the reliability threshold setting unit 512 decides the detection region as the non-detection region in step S610.

According to the second embodiment, by changing the reliability threshold based on the reliability of the non-detection region, it is possible to prevent detection of a subject differing from a user's intention and focusing on the subject.

### Third Embodiment

Similar to the first and second embodiments, the third embodiment will describe an example in which an image processing apparatus 100 is a digital camera and a detection error is suppressed based on the position and size of a non-detection region on an input image. Similar to the first and second embodiments, the third embodiment assumes a scene in which part of a kitchen is erroneously detected as a face of a person in an input image 400 shown in FIG. 4.

### Apparatus Configuration

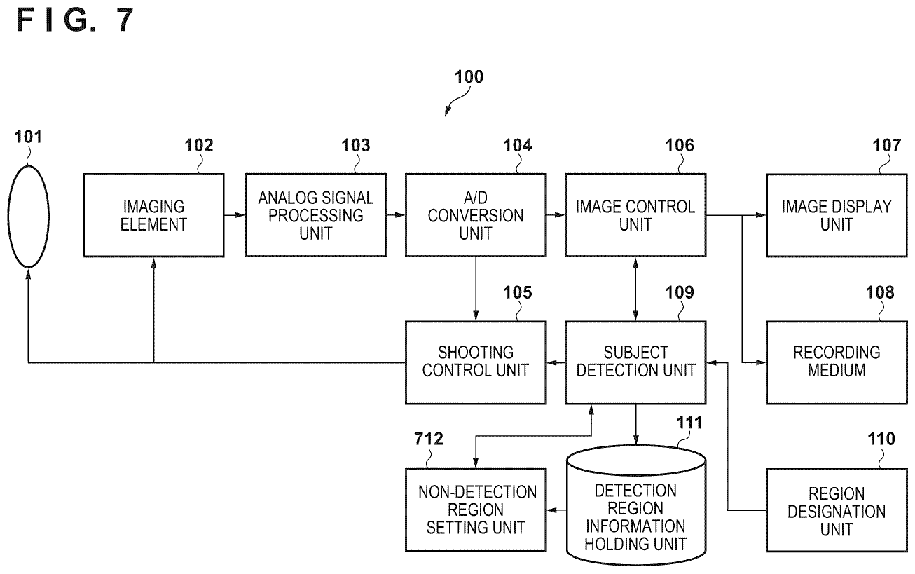

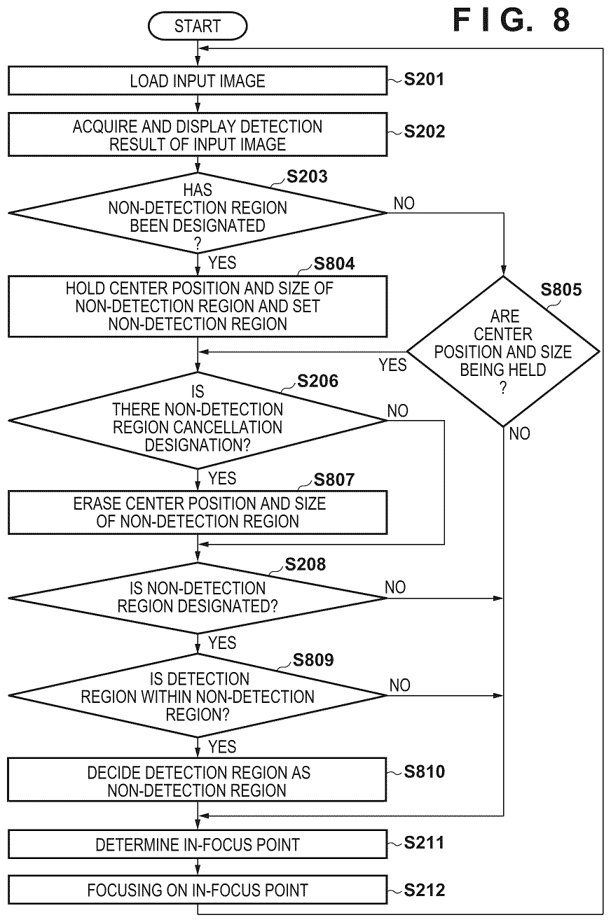

FIG. 7 is a block diagram showing an example of the functional configuration of an image processing apparatus according to the third embodiment. The image processing apparatus 100 according to the third embodiment includes a non-detection region setting unit 712 as a decision means different from that in the first embodiment.

Similar to the image processing apparatus 100 according to the first embodiment, the image processing apparatus 100 shown in FIG. 7 has a function of detecting a face of a person as a specific subject from the input image and focusing on the detected face of the person.

The same components as those in the first embodiment are given with the same names and reference numerals as in the first embodiment. A repetitive description of the same components will be omitted.

A subject detection unit 109 holds, in a detection region information holding unit 111, the center position and size of a non-detection region including a position on the input image designated by the user using a region designation unit 110.

The non-detection region setting unit 712 can suppress a detection error by setting, as a non-detection region on the next input image, a region having the center position and size of the non-detection region held in the detection region information holding unit 111 from a frame (image) in which the non-detection region is designated.

### Processing Procedure

A method of designating a non-detection region according to this embodiment will be described next. FIG. 8 is a flowchart illustrating processing of the image processing apparatus according to the third embodiment. The processing shown in FIG. 8 is implemented when a CPU of the image processing apparatus 100 deploys a control program stored in a ROM to the work area of a RAM and executes it after power-on of the image processing apparatus 100 (digital camera). Note that in FIG. 8, the same processing steps as in FIG. 2 of the first embodiment are denoted by the same step numbers and a description thereof will be omitted.

In step S804, an image control unit 106 changes, to a non-detection region, the detection region designated by the user using the region designation unit 110, and the detection region information holding unit 111 holds the center position and size of the non-detection region. The non-detection region setting unit 712 sets, in the input image, as a non-detection region, a region based on the center position and size of the non-detection region.

In step S805, the subject detection unit 109 determines whether the detection region information holding unit 111 holds the center position and size of the non-detection region. If the center position and size of the non-detection region are not held (NO in step S805), the subject detection unit 109 advances the process to step S211. If the detection region information holding unit 111 holds the center position and size of the non-detection region (YES in step S805), the subject detection unit 109 advances the process to step S206.

In step S807, the subject detection unit 109 erases the center position and size of the non-detection region from the detection region information holding unit 111, cancels the designation of the non-detection region, and advances the process to step S208.

In step S809, if the center position of the detection region of the input image is included in the non-detection region (YES in step S809), the non-detection region setting unit 712 decides the detection region as the non-detection region in step S810. If the center position of the detection region of the input image is outside the non-detection region (NO in step S809), the non-detection region setting unit 712 advances the process to step S211.

In this embodiment, whether the subject center (the center of the detection region) is included in the non-detection region is set as the determination condition of a non-detection region but the area of the non-detection region may be expanded twice or three times. Furthermore, in consideration of the size of the subject, the size difference between the subject and the subject in the non-detection region may be added to the determination condition of the non-detection region. Alternatively, Intersection over Union (IoU) based on the detection region and the non-detection region may be set as the determination condition of a non-detection region, but the present invention is not limited to these.

According to the third embodiment, it is possible to suppress a detection error of a subject differing from a user's intention by setting, in the input image, as a non-detection region, a region based on the center position and size of the non-detection region.

### Fourth Embodiment

Similar to the first, second, and third embodiments, in the fourth embodiment, an image processing apparatus 100 is a digital camera. An example in which a subject (detection region) differing from a user's intention is decided as a non-detection region based on the detection category of a non-detection region will be described.

### Apparatus Configuration

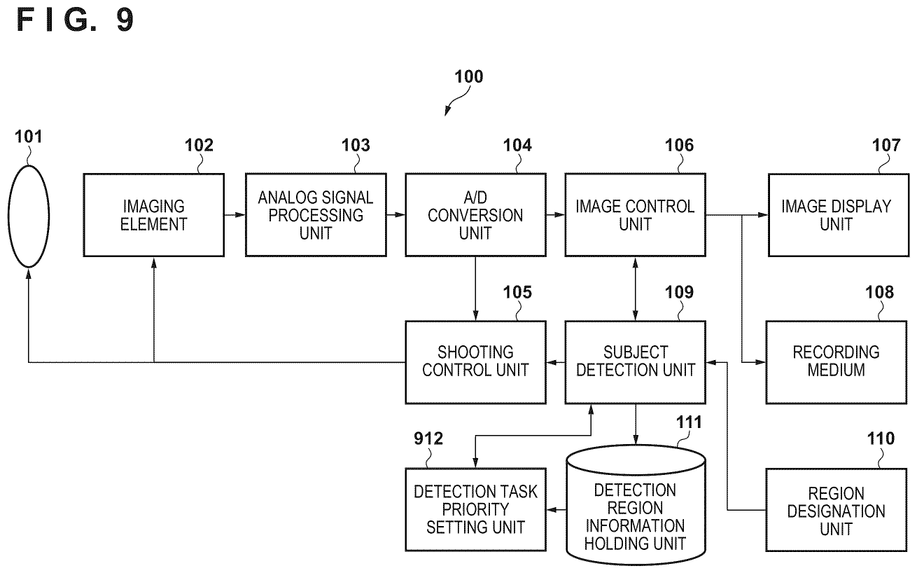

FIG. 9 is a block diagram showing an example of the functional configuration of an image processing apparatus according to the fourth embodiment. The image processing apparatus 100 according to the fourth embodiment includes a detection task priority setting unit 912 as a decision means different from that in the first embodiment.

The image processing apparatus 100 shown in FIG. 9 has a function of detecting one of a person, an animal, and a vehicle as a specific subject from an input image and focusing on the detected subject.

The same components as those in the first embodiment are given with the same names and reference numerals as in the first embodiment. A repetitive description of the same components will be omitted.

A subject detection unit 109 holds, in a detection region information holding unit 111, the detection category of a non-detection region including a position on the input image designated by the user using a region designation unit 110.

The detection task priority setting unit 912 (setting means) sets the priority of a detection task corresponding to the detection category held in the detection region information holding unit 111 to be lower than those of other detection tasks from a frame (image) in which the non-detection region is designated. Alternatively, the detection task priority setting unit 912 suppresses detection of the non-detection region by excluding the detection task corresponding to the detection category of the non-detection region from detection tasks executed by the subject detection unit 109.

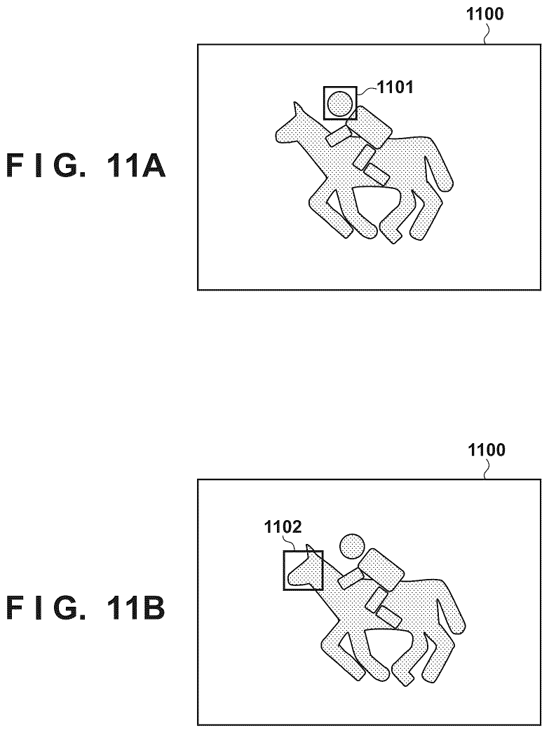

FIGS. 11A and 11B are views each showing an example of an input image according to the fourth embodiment. FIG. 11A shows an input image obtained by capturing a horse riding scene. Although the user wants to detect a face of a horse, the subject detection unit 109 detects a face of a person from an input image 1100. A detection region 1101 is displayed on the face of the person. In this case, the detection task priority setting unit 912 makes a setting of changing the priority of the detection task, thereby making it possible to detect the subject intended by the user, that is, the face (a detection region 1102) of the horse, as shown in FIG. 11B.

### Processing Procedure

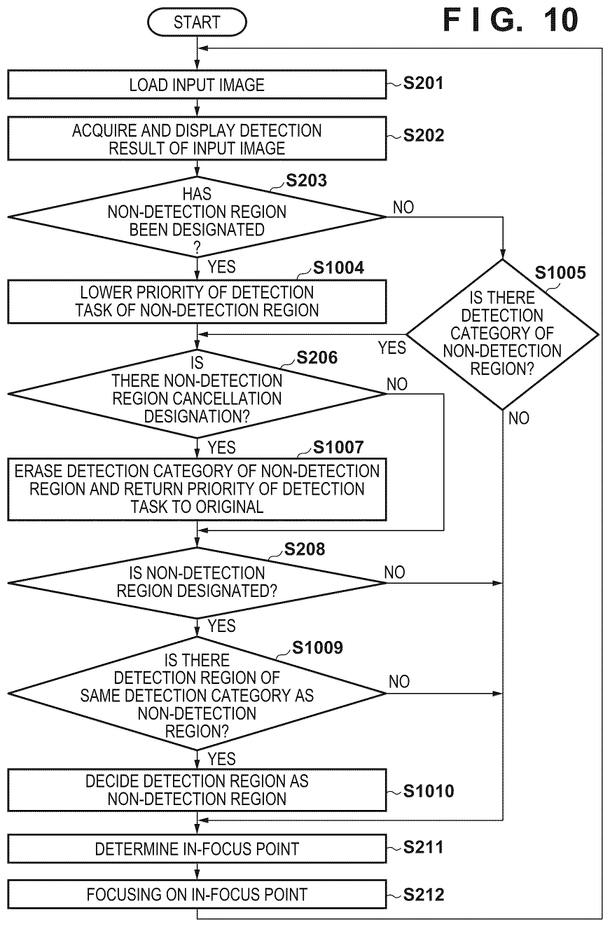

A method of designating a non-detection region according to this embodiment will be described next. FIG. 10 is a flowchart illustrating processing of the image processing apparatus according to the fourth embodiment. The processing shown in FIG. 10 is implemented when a CPU of the image processing apparatus 100 deploys a control program stored in a ROM to the work area of a RAM and executes it after power-on of the image processing apparatus 100 (digital camera).

The same processing steps as in FIG. 2 of the first embodiment are denoted by the same step numbers and a description thereof will be omitted.

In step S1004, an image control unit 106 changes, to a non-detection region, the detection region designated by the user using the region designation unit 110, and the detection region information holding unit 111 holds the center position and size of the non-detection region. The detection task priority setting unit 912 changes the setting of the priority of the detection task. That is, if the current priority order of the detection tasks is the order of a person detection task, an animal detection task, and a vehicle detection task, the detection task priority setting unit 912 lowers the priority of the person detection task. This sets the priority order of the detection tasks to the order of the animal detection task, the vehicle detection task, and the person detection task. Alternatively, the detection task priority setting unit 912 excludes the person detection task from the set (including the animal detection task, the vehicle detection task, and the person detection task) of the detection tasks executed by the subject detection unit 109.

In step S1005, the subject detection unit 109 determines whether the detection region information holding unit 111 holds the detection category of the non-detection region. If the detection category of the non-detection region is not held (NO in step S1005), the subject detection unit 109 advances the process to step S211. If the detection region information holding unit 111 holds the detection category of the non-detection region (YES in step S1005), the subject detection unit 109 advances the process to step S206.

In step S1007, the subject detection unit 109 erases the detection category of the non-detection region from the detection region information holding unit 111, returns the priorities of the detection tasks, and advances the process to step S208.

In step S1009, if the detection category of the detection region in the input image is the same as the detection category of the non-detection region (YES in step S1009), the detection task priority setting unit 912 decides the detection region in the input image as the non-detection region in step S1010.

If the detection category of the detection region in the input image is not the same as the detection category of the non-detection region (NO in step S1009), the detection task priority setting unit 912 advances the process to step S211.

According to the fourth embodiment, it is possible to suppress a detection error of a subject differing from a user's intention by lowering the priority of the detection task corresponding to the detection category of the non-detection region or excluding the detection task. As a result, the user can detect the subject intended by the user, and does not miss the opportunity to capture an image.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-021445, filed Feb. 15, 2024 which is hereby incorporated by reference herein in their entirety.

What is claimed is:

1. An image processing apparatus comprising:
at least one processor; and
at least one memory coupled to the at least one processor, the at least one memory storing instructions that, when executed by the at least one processor, cause the at least one processor to:
detect a subject in an image;
display the image and a detection region of the subject;
designate, as a non-detection region, the detection region displayed;
hold information of the non-detection region designated; and
decide, based on the information of the non-detection region, a non-detection region in another image displayed after the image.

2. The apparatus according to claim 1,
wherein the instructions, when executed by the at least one processor, further cause the at least one processor to acquire an image feature amount of the non-detection region and an image feature amount of a detection region of a subject detected in the other image,
wherein the at least one processor decides, as the non-detection region, the detection region of the subject detected in the other image having a high correlation with the non-detection region based on the image feature amount of the non-detection region and the image feature amount of the detection region of the subject detected in the other image.

3. The apparatus according to claim 2, wherein the at least one processor acquires an image feature amount of a non-detection region wider than the non-detection region.

4. The apparatus according to claim 3, wherein the wider non-detection region is a region including the non-detection region and a peripheral region of the non-detection region.

5. The apparatus according to claim 2, wherein the at least one processor acquires an image feature amount of a peripheral region of the non-detection region.

6. The apparatus according to claim 2,
wherein the instructions, when executed by the at least one processor, further cause the at least one processor to learn, based on the image feature amount of the non-detection region, a detector that does not detect the subject of the non-detection region,
wherein the at least one processor includes the learned detector.

7. The apparatus according to claim 1, wherein the at least one processor decides, as the non-detection region, a detection region of a subject detected in the other image based on a reliability threshold decided using reliability of the non-detection region.

8. The apparatus according to claim 1, wherein the at least one processor decides, as the non-detection region, a detection region of a subject detected in the other image by setting, in the other image, a region based on a center position and a size of the non-detection region on the image.

9. The apparatus according to claim 1, wherein the instructions, when executed by the at least one processor, further cause the at least one processor to set a priority of a detection task of the at least one processor executed for the non-detection region to be lower than a priority of another detection task,
wherein the at least one processor decides, as the non-detection region, a detection region of a subject detected in the other image based on the setting.

10. The apparatus according to claim 9, wherein the at least one processor sets to exclude the detection task of the at least one processor executed for the non-detection region from detection tasks executed by the at least one processor.

11. The apparatus according to claim 1, wherein the instructions, when executed by the at least one processor, further cause the at least one processor to cancel the designation of the non-detection region.

12. An image capturing apparatus comprising:
an image processing apparatus according to claim 1;
an image capturing unit; and
a shooting control unit configured to control the image capturing unit not to focus on a non-detection region.

13. A method comprising:
detecting a subject in an image;
displaying the image and a detection region of the subject;
designating, as a non-detection region, the detection region displayed;
holding information of the non-detection region designated; and
deciding, based on the information of the non-detection region, a non-detection region in another image displayed after the image.

14. A non-transitory computer readable storage medium storing instructions that, when executed by a computer, cause the computer to perform a method comprising:
detecting a subject in an image;
displaying the image and a detection region of the subject;
designating, as a non-detection region, the detection region displayed;
holding information of the non-detection region designated; and
deciding, based on the information of the non-detection region, a non-detection region in another image displayed after the image.
